(19) United States
(12) Patent Application Publication
(10) Pub. No.: US 2008/0120783 A1
(43) Pub. Date: May 29, 2008

(54) Nanofiber allergen barrier fabric

(76) Inventors: Warren Francis Knoff, Richmond, VA (US); Dariusz Wlodzimierz Kawka, Midlothian, VA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/506,022

(22) Filed: Aug. 17, 2006

(51) Int. Cl. A47C 17/00; A47C 31/00; A47G 9/00; A47G 9/02; A47G 9/10; A41D 1/02; B32B 5/24

(52) U.S. Cl. 5/636; 5/482; 5/490; 5/500; 5/502; 5/699; 2/108; 428/311.11; 442/76; 442/123

(57) ABSTRACT

An allergen-barrier fabric comprising at least one porous layer of polymeric nanofibers, a fabric layer superjacent and adhered to the nanofiber layer, and optionally a fabric layer subjacent and adhered to the nanofiber layer, wherein the superjacent and optional subjacent fabric layers are adhered to said nanofiber layer such that the allergen-barrier fabric has a mean flow pore size of between about 0.01 μm and about 10 μm, and a Frazier air permeability of at least about 1.5 m³/min/m².

### BACKGROUND

A major source of indoor allergy-causing proteins are dust mites. Dust mites, 100 to 300 microns in size, cannot be seen with the naked eye. Dust mite excrement, which is a key component that causes allergic reactions, is even smaller, ranging in size down to 10 microns. Thus, in order to be an effective barrier to dust, dust mites, and their allergy-causing particles, a fabric or material must limit the transmission of 10 micron particles through its planar surface. These facts are discussed, for example, in Platts-Mills et al., “Dust Mite Allergens and Asthma: Report of a Second International Workshop,” J. Allergy Clin. Immunology, 1992, Vol. 89, pp. 1046-1060 (“Several studies have demonstrated that the bulk of airborne group I mite allergen is associated with the relatively ‘large’ fecal particle, 10 to 40 Vm in diameter.”); and U.S. Pat. No. 5,050,256 to Woodcock, et al., both of which are entirely incorporated herein by reference.

Woodcock et al. “Fungal contamination of bedding” Allergy 2006: 61: 140-142 details a new threat for allergy sufferers. Within the excrement of dust mites, fungal spores of 2-30 microns in diameter are growing inside pillows. These spores escape the pillows and may cause allergic reactions.

The major concentration of dust mites and fungal spores in the home is found in the bedroom. For example, an average mattress can support a colony of 2 million dust mites. Pillows also are an excellent habitat for dust mites. Six-year old pillows typically have 25% of their weight made up of dust, dust mites, and allergen. Sofa cushions, chair cushions, carpets, and other foam or fiber filled articles also provide a suitable habitat for dust mites. In effect, every home contains many areas where dust mites can thrive.

Additionally, the presence of allergens from dust mites and fungal spores is a problem that increases as pillows, mattresses, and the like become older. During its lifetime, a typical dust mite produces up to 200 times its net body weight in excrement. This excrement contains the allergen that triggers asthma attacks and allergic reactions, including congestion, red eyes, sneezing, and headaches. The problem is exacerbated by the fact that it is difficult to remove dust mites from the materials in which they thrive. Pillows are rarely laundered, while most mattresses are never washed.

Commercially-available allergy-relief bedding products offer a wide array of claims regarding their efficacy as allergen barriers. However, laminated or coated materials typically are uncomfortable, stiff, not soft to the touch, and noisy (i.e., make relatively loud, rustling noises when a person moves on the sheet or pillow). Additionally, while vinyl, polyurethane, and microporous coated fabrics require venting when used as pillow or mattress tickings since air flow is not possible through these materials. Pillows or mattresses covered with these materials cannot deflate and re-inflate when compressed, unless they are vented. The need to vent these fabrics, however, begs the question of whether they can be considered effective allergen barriers (as allergens can also enter and escape through the vents). Coated and laminated fabrics also tend to have a limited wearlife due to coating delamination.

Uncoated cotton sheetings, although promoted as such, are not true barriers to allergens due to their inherently large pore sizes. Allergy specialists routinely urge patients to launder their bedding products on a weekly basis. Such practices, however, only serve to further enlarge the pore size of cotton sheetings as fiber is lost with extended laundering.

Spunbond/meltblown/spunbond (SMS) polyolefin nonwovens used in mattress and pillow covers are also used as barrier protection to allergens.

U.S. Pat. No. 5,050,256 issued to Woodcock describes an allergen proof bedding system with a cover permeable to water vapor. The cover material described in this patent is made of Baxenden Witcoflex 971/973 type polyurethane-coated woven polyester or nylon fabric.

U.S. Pat. No. 5,368,920 issued to Schortmann (International Paper Co.) describes a nonporous, breathable barrier fabric and related methods of manufacture. The fabric is created by filling void spaces in a fabric substrate with film-forming clay-latex material, to provide a barrier fabric permeable to water vapor and impermeable to liquids and air.

Dancey, in U.S. Pat. No. 5,321,861, describes a microporous ultrafilter material having a pore size of less than 0.0005 mm with welded seams, having its opening sealed by a resealable fastener, such as a zip-fastener, covered with an adhesive tape.

There is a need for an allergen barrier which provides excellent barrier to household allergens while allowing the efficient passage of air.

### SUMMARY OF THE INVENTION

In one embodiment, the present invention is directed to a mattress having a microporous covering material comprising a nanofiber layer comprising at least one porous layer of polymeric nanofibers having a number average diameter of said nanofibers between about 50 nm to about 1000 nm, said nanofiber layer having a mean flow pore size of between about 0.01 μm and about 10 μm, a basis weight of between about 1 g/m² and about 30 g/m², a Frazier air permeability of at least about 1.5 m³/min/m², a fabric layer superjacent and adhered to the nanofiber layer, and optionally a fabric layer subjacent and adhered to the nanofiber layer, wherein the superjacent and optional subjacent fabric layers are adhered to said nanofiber layer such that the allergen-barrier fabric has a mean flow pore size of between about 0.01 μm and about 10 μm, and a Frazier air permeability of at least about 1.5 m³/min/m².

Another embodiment of the present invention is directed to a pillow comprising an allergen-barrier fabric, said allergen-barrier fabric comprising at least one porous layer of polymeric nanofibers having a number average diameter of said nanofibers between about 50 nm to about 1000 nm, said nanofiber layer having a mean flow pore size of between about 0.01 μm and about 10 μm, a basis weight of between about 1 g/m² and about 30 g/m², a Frazier air permeability of at least about 1.5 m³/min/m², a fabric layer superjacent and adhered to the nanofiber layer, and optionally a fabric layer subjacent and adhered to the nanofiber layer, wherein the superjacent and optional subjacent fabric layers are adhered to said nanofiber layer such that the allergen-barrier fabric has a mean flow pore size of between about 0.01 μm and about 10 μm, and a Frazier air permeability of at least about 1.5 m³/min/m².

Another embodiment of the present invention is directed to a bed covering comprising an allergen-barrier fabric, said allergen-barrier fabric comprising at least one porous layer of polymeric nanofibers having a number average diameter of said nanofibers between about 50 nm to about 1000 nm, said nanofiber layer having a mean flow pore size of between about 0.01 μm and about 10 μm, a basis weight of between about 1 g/m² and about 30 g/m², a Frazier air permeability of at least about 1.5 m³/min/m², a fabric layer superjacent and adhered to the nanofiber layer, and optionally a fabric layer subjacent and adhered to the nanofiber layer, wherein the superjacent and optional subjacent fabric layers are adhered to said nanofiber layer such that the allergen-barrier fabric has a mean flow pore size of between about 0.01 μm and about 10 μm, and a Frazier air permeability of at least about 1.5 m³/min/m².

Another embodiment of the present invention is directed to a liner for an article susceptible to allergen-penetration comprising an allergen-barrier fabric, said allergen-barrier fabric comprising at least one porous layer of polymeric nanofibers having a number average diameter of said nanofibers between about 50 nm to about 1000 nm, said nanofiber layer having a mean flow pore size of between about 0.01 μm and about 10 μm, a basis weight of between about 1 g/m² and about 30 g/m², a Frazier air permeability of at least about 1.5 m³/min/m², a fabric layer superjacent and adhered to the nanofiber layer, and optionally a fabric layer subjacent and adhered to the nanofiber layer, wherein the superjacent and optional subjacent fabric layers are adhered to said nanofiber layer such that the allergen-barrier fabric has a mean flow pore size of between about 0.01 μm and about 10 μm, and a Frazier air permeability of at least about 1.5 m³/min/m².

Another embodiment of the present invention is directed to an allergen-barrier fabric comprising at least one porous layer of polymeric nanofibers having a number average diameter of said nanofibers between about 50 nm to about 1000 nm, said nanofiber layer having a mean flow pore size of between about 0.01 μm and about 10 μm, a basis weight of between about 1 g/m² and about 30 g/m², a Frazier air permeability of at least about 1.5 m³/min/m², a fabric layer superjacent and adhered to the nanofiber layer, and optionally a fabric layer subjacent and adhered to the nanofiber layer, wherein the superjacent and optional subjacent fabric layers are adhered to said nanofiber layer such that the allergen-barrier fabric has a mean flow pore size of between about 0.01 μm and about 10 μm, and a Frazier air permeability of at least about 1.5 m³/min/m².

### BRIEF DESCRIPTION OF THE DRAWINGS

FIG. 1 is a representation of a prior art allergen-barrier fabric made from webs of relatively large fibers, such as meltblown or spunbond webs.

FIG. 2 is a representation of the allergen-barrier fabrics of the present invention, wherein a conventional fabric web is overlaid by a nanofiber web.

### DETAILED DESCRIPTION OF THE INVENTION

The present inventors have determined that the incorporation of a nonwoven fabric web comprising polymeric nanofibers into a fabric for use in coverings for articles susceptible to allergen penetration can act as an effective allergen-barrier. The polymeric nanofiber-containing web can be adhered to one or more other fabric webs to form an allergen-barrier fabric, for use in coverings such as mattress or pillow covers, mattress or pillow ticking, mattress pads, duvet covers and even linings for apparel containing allergens, such as linings for down jackets and the like.

Ticking is the non-removable fabric covering that encases the fiberfill or other padding of a pillow or mattress. Pillow or mattress covers are the removable fabrics that cover the pillow or mattress, and can also function as a decorative, washable encasement (e.g., a pillow case). For allergy sufferers, a pillow cover also can function as an allergen barrier. Pillow-cover closures are usually either zippers or overlapping flaps. Institutional mattress covers also must provide a barrier to fluids. For allergy sufferers, such a cover also can function as an allergen barrier. Mattress-cover closures typically are either zippers or overlapping flaps. A mattress pad is a quilted removable covering for a mattress. For allergy sufferers, the innermost or the outermost fabric in the pad can function as an allergen barrier.

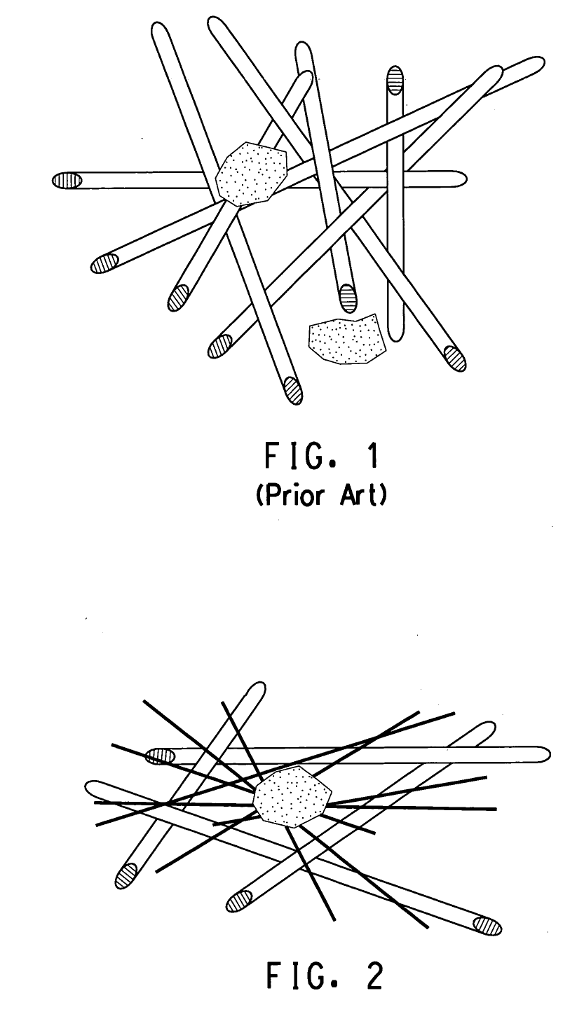

The allergen-reducing effect of the polymeric nanofiber web is believed to be due to the decrease in mean flow pore size of such webs, as compared to more conventional allergen-barrier fabrics, such as spunbond or meltblown nonwoven webs or tightly-woven fabrics. FIG. 1 is a representation of a magnified conventional prior art nonwoven web, such as a spunbond or meltblown web, which shows the pore size between fibers relative to the size of a typical allergen particle.

The polymeric nanofiber-containing webs of the present invention comprise at least one porous layer of polymeric nanofibers having a number average diameter of said nanofibers between about 50 nm to about 1000 nm, even between about 200 nm to about 800 nm, or even between about 300 nm and 700 nm, and have a mean flow pore size of between about 0.01 μm and about 10 μm, even between about 0.5 μm and about 3 μm.

The decrease in mean flow pore size relative to conventional allergen-barrier fabrics is due to the great increase in the number of fibers deposited per unit of surface area (and volume) of the nanofiber webs according to the present invention. FIG. 2 is a representation of an allergen-barrier fabric according to the present invention, wherein a conventional nonwoven web layer is overlaid with a layer of nanofibers. It can be seen that the number of nanofibers which can be deposited in a given unit of surface area of the fabric is much higher than for the conventional fabric webs. Much smaller pores are formed between the nanofibers themselves and between the nanofibers and the underlying nonwoven web fibers, resulting in much better allergen-barrier properties, while retaining a high air flow capability through the web.

Polymeric nanofiber-containing webs are known in the prior art, and can be produced by techniques such as electrospinning or electroblowing. Both electrospinning and electroblowing techniques can be applied to a wide variety of polymers, so long as the polymer is soluble in a solvent under relatively mild spinning conditions, i.e. substantially at ambient conditions of temperature and pressure. Nanofiber webs according to the present invention can be made from polymers such as alkyl and aromatic polyamides, polyimides, polybenzimidazoles, polybenzoxazoles, polybenzthiazoles, polyethers, polyesters, polyurethanes, polycarbonates, polyureas, vinyl polymers, acrylic polymers, styrenic polymers, halogenated polyolefins, polydienes, polysulfides, polysaccharides, polylactides, and copolymers, derivative compounds or combinations thereof. Particularly suitable polymers include nylon-6, nylon-6,6, poly(ethylene terephthalate), polyanilines, poly(ethylene oxide), poly(ethylene naphthalate), poly(butylene terephthalate), styrene butadiene rubbers, poly(vinyl chloride), poly(vinyl alcohol), poly(vinylidene fluoride) and poly(vinyl butylene).

The polymer solution is prepared by selecting a solvent according to the above polymers. Suitable solvents include water, alcohols, formic acid, dimethylacetamide and dimethyl formamide. The polymer solution can be mixed with additives including any resins compatible with an associated polymer, plasticizers, ultraviolet ray stabilizers, crosslinking agents, curing agents, reaction initiators, colorants such as dyes and pigments, etc. Although dissolving most of the polymers may not require any specific temperature ranges, heating may be needed for assisting the dissolution reaction.

In the fiber-spinning process known as electrospinning, a high voltage is applied to a polymer in solution to create nanofibers and nonwoven mats. The polymer solution is loaded into a syringe, and high voltage is applied to the solution within the syringe. Charge builds up on a droplet of solution that is suspended at the tip of the syringe needle. Gradually, as this charge overcomes the surface tension of the solution, this droplet elongates and forms a Taylor cone. Finally, the solution exits from the tip of the Taylor cone as a jet, which travels through the air to its target medium. One drawback of conventional electrospinning, as illustrated in U.S. Pat. No. 4,127,706, is very low throughput of spinning solution, which means that forming nanofiber webs of sufficient size for commercial use is time consuming and impractical. Even the improved electrospinning process described in U.S. Pat. No. 6,673,136, utilizing a number of rotating electrospinning heads, is limited in its production potential.

In contrast, when using the electroblowing process disclosed in International Publication Number WO2003/080905 (U.S. Ser. No. 10/822,325), which is hereby incorporated by reference, nanofiber webs having basis weights of at least about 1 g/m² or higher are readily available in commercial quantities.

The electroblowing method comprises feeding a stream of polymeric solution comprising a polymer and a solvent from a storage tank to a series of spinning nozzles within a spinneret, to which a high voltage is applied and through which the polymeric solution is discharged. Meanwhile, compressed air that is optionally heated is issued from air nozzles disposed in the sides of, or at the periphery of the spinning nozzle. The air is directed generally downward as a blowing gas stream which envelopes and forwards the newly issued polymeric solution and aids in the formation of the fibrous web, which is collected on a grounded porous collection belt above a vacuum chamber.

The number average fiber diameter of the nanofibers deposited by the electroblowing process is less than about 1000 nm, or even less than about 800 nm, or even between about 50 nm to about 500 nm, and even between about 100 nm to about 400 nm. Each nanofiber layer can have a basis weight of at least about 1 g/m², even between about 1 g/m² to about 40 g/m², and even between about 5 g/m² to about 20 g/m². Each nanofiber layer can have a thickness of about 20 μm to about 500 μm, and even between about 20 μm to about 300 μm.

In contrast to the use of microporous films as allergen-barrier materials, which have extremely poor air flow permeability, the nanofiber layers of the present invention demonstrate Frazier air permeabilities of at least about 1.5 m³/min/m², or even at least about 2 m³/min/m², or even at least about 4 m³/min/m², and even up to about 6 m³/min/m². The high air flow through the nanofiber layers of the present invention result in allergen-barrier fabrics providing great comfort to the user due to their breathability, while still maintaining a low level of allergen penetration.

In order to impart durability to the allergen-barrier fabrics, the nanofiber layer is adhered to at least one fabric layer, and optionally to two fabric layers, one on either side of the nanofiber layer. The additional fabric layers can be adhered to the nanofiber layer by thermal adhesion, e.g. using hot melt adhesive or ultrasonic bonding; chemical adhesion, e.g. layer attachment using solvent-based adhesives; or mechanical adhesion, e.g. attachment by sewing, hydroentanglement, or depositing the nanofiber layer directly onto a fabric layer. These adhesion techniques may also be used in combination, where appropriate or desirable. The durability of the allergen-barrier fabrics of the present invention is such that they can withstand at least 10 washings, and even up to 50 washings, without mechanical separation or delamination of the various fabric layers.

The additional fabric layers which can be adhered to the nanofiber layer are not particularly limited, so long as they do not greatly adversely affect the air flow permeability of the nanofiber layer. For example, the additional fabric layers can be woven fabrics, knitted fabrics, nonwoven fabrics, scrims or tricots. It is preferable that the air flow permeability of the combined layers be the same as that of the nanofiber layer, i.e. that the additional fabric layers do not affect the Frazier permeability of the nanofiber layer at all. As such, the allergen-barrier fabrics of the present invention demonstrate Frazier air permeabilities of at least about 1.5 m³/min/m², or even at least about 2 m³/min/m², or even at least about 4 m³/min/m², and even up to about 6 m³/min/m².

Chemical enhancements to the fabric according to the invention include the application of a permanent antimicrobial finish and/or a flexible fluorochemical finish. In this context, “permanent” denotes efficacy of the respective finishes for the lifetime of the product. Any suitable antimicrobial or fluorochemical finish can be used without departing from this invention, and such finishes are known in the art (see, for example, U.S. Pat. No. 4,822,667).

As an example of a suitable antimicrobial finish, a very durable compound of 3-(trimethoxysilyl)-propyidimethyloctadecyl ammonium chloride (Dow Coming 5700) can be applied. This finish protects the fabric against bacteria and fungi, and inhibits the growth of odor-causing bacteria. It has been shown to be effective against bacteria (Streptococcus faecalis, K. pneumoniae), fungus (Aspergillus niger), yeast (Saccharomyces cerevisiae), wound isolates (Citrobacter diversus, Staphylococcus aureus, Proteus mirabilis), and urine isolates (Pseudomonas aeruginosa, E. coli).

The fluorochemical finish can be a permanent micro-thin flexible fluorochemical film that imparts fluid repellency, so as to enhance the stain resistance from, e.g. liquid spills, of the inventive allergen-barrier fabrics.

### EXAMPLES

The process for making the nanofiber layer(s) for use in the allergy barrier of the invention is disclosed in International Publication Number WO2003/080905, discussed above. The following test methods were used in assessing the examples below.

Basis Weight was determined by ASTM D-3776, which is hereby incorporated by reference and reported in g/m².

Fiber Diameter was determined as follows. Ten scanning electron microscope (SEM) images at 5,000× magnification were taken of each nanofiber layer sample. The diameter of eleven (11) clearly distinguishable nanofibers were measured from the photographs and recorded. Defects were not included (i.e., lumps of nanofibers, polymer drops, intersections of nanofibers). The average (mean) fiber diameter for each sample was calculated.

Frazier Air Permeability is a measure of air permeability of porous materials and is reported in units of ft³/min/ft². It measures the volume of air flow through a material at a differential pressure of 0.5 inches (12.7 mm) of water. An orifice is mounted in a vacuum system to restrict flow of air through sample to a measurable amount. The size of the orifice depends on the porosity of the material. Frazier permeability is measured in units of ft³/min/ft² using a Sherman W. Frazier Co. dual manometer with calibrated orifice, and converted to units of m³/min/m².

Mean Flow Pore Size was measured according to ASTM Designation E 1294-89, “Standard Test Method for Pore Size Characteristics of Membrane Filters Using Automated Liquid Porosimeter” which approximately measures pore size characteristics of membranes with a pore size diameter of 0.05 μm to 300 μm by using automated bubble point method from ASTM Designation F 316 using a capillary flow porosimeter (model number CFP-34RTF8A-3-6-L4, Porous Materials, Inc. (PMI), Ithaca, N.Y.). Individual samples were wetted with low surface tension fluid (1,1,2,3,3,3-hexafluoropropene, or “Galwick,” having a surface tension of 16 dyne/cm). Each sample was placed in a holder, and a differential pressure of air was applied and the fluid removed from the sample. The differential pressure at which wet flow is equal to one-half the dry flow (flow without wetting solvent) is used to calculate the mean flow pore size using supplied software.

Washing Test was performed on a standard GE washing machine available from Lowe's. The fabrics were washed for 10 cycles of 5 washings on the Warm/Cold setting. Each sample was fully dried between cycles with no hot air drying. No soap or detergent was used during the washing. Samples were visually inspected for mechanical failure or delamination.

### Example 1

To a first side of a nanofiber layer of Nylon-6,6 having a number average fiber diameter of about 400 nm, basis weight of about 10 gsm, Frazier permeability of 6 m³/min/m², and mean flow pore diameter of 1.8 microns was applied a polyurethane adhesive solution from a patterned application roll. A 225 cotton count woven plain weave cotton fabric was simultaneously contacted to and co-extensively with the first side of the porous sheet. The structure was then calendered through a nip and allowed to cure for 24 hours.

To the second side of the nanofiber layer was applied a polyurethane adhesive solution from the same patterned application roll. A 120 cotton count woven plain weave cotton fabric was simultaneously contacted to and co-extensively with the second side of the nanofiber layer. The structure was then calendered through a nip and allowed to cure for 24 hours and the solvent was allowed to evaporate. The Frazier permeability of the resulting structure was 1.8 m³/min/m² and mean flow pore size was 1.5 microns.

### Example 2

To a first side of a nanofiber layer of Nylon-6,6 having number average fiber diameter of about 400 nm, basis weight of 10 gsm, Frazier permeability of 6 m³/min/m², and mean flow pore diameter of 1.8 microns was applied a polyurethane adhesive solution from a patterned application roll. A nylon tricot was simultaneously contacted to and co-extensively with the first side of the nanofiber layer. The structure was then calendered through a nip and allowed to cure for 24 hours.

To the second side of the nanofiber layer was applied a polyurethane adhesive solution from the same patterned application roll. A nylon nonwoven ripstop was simultaneously contacted to and co-extensively with the second side of the nanofiber layer. The structure was then calendered through a nip and allowed to cure for 24 hours, and the solvent was allowed to evaporate. The Frazier permeability of the resulting structure was 3.9 m³/min/m². This process was repeated with the nanofiber layers of Nylon-6,6 having number average fiber diameters of about 450 nm, about 700 nm, and about 1000 nm. The Frazier permeability of the resulting structures were 4.7, 5.4 and 5.9 m³/min/m² respectively.

### Example 3

To a first side of a nanofiber layer of Nylon-6,6 having a number average fiber diameter of about 400 nm, basis weight of 10 gsm, Frazier permeability of 6 m³/min/m², and mean flow pore diameter of 1.8 microns was applied a polyurethane adhesive solution from a patterned application roll. A 225 cotton count woven plain weave cotton fabric was simultaneously contacted to and co-extensively with the first side of the nanofiber layer. The structure was then calendered through a nip and allowed to cure for 24 hours.

To the second side of the nanofiber layer was applied a polyurethane adhesive solution from the same patterned application roll. A 17 gsm polyethylene nonwoven sheet was simultaneously contacted to and co-extensively with the second side of the nanofiber layer. The structure was then calendered through a nip and allowed to cure for 24 hours, and the solvent was allowed to evaporate. The Frazier permeability of the resulting structure was 1.8 m³/min/m² and mean flow pore size was 2.9 microns.

### Example 4

To a first side of a nanofiber layer of Nylon-6,6 having a number average fiber diameter of about 400 nm, basis weight of 10 gsm, Frazier permeability of 6 m³/min/m², and mean flow pore diameter of 1.8 microns was applied a polyurethane adhesive solution from a patterned application roll. A nylon tricot was simultaneously contacted to and co-extensively with the first side of the nanofiber layer. The structure was then calendered through a nip and allowed to cure for 24 hours.

To the second side of the nanofiber layer was applied a polyurethane adhesive solution from the same patterned application roll. A polyester ripstop was simultaneously contacted to and co-extensively with the second side of the nanofiber layer. The structure was then calendered through a nip and allowed to cure for 24 hours, and the solvent was allowed to evaporate. The structure was cut into 8×10 inch sheets and wash tested. No delamination or mechanical failure was observed. The Frazier permeability after wash testing was determined to be 1.8 m³/min/m².

We claim:

1. A mattress having a microporous covering material comprising:
a nanofiber layer comprising at least one porous layer of polymeric nanofibers having a number average diameter of said nanofibers between about 50 nm to about 1000 nm, said nanofiber layer having a mean flow pore size of between about 0.01 μm and about 10 μm, a basis weight of between about 1 g/m² and about 30 g/m², a Frazier air permeability of at least about 1.5 m³/min/m²,
a fabric layer superjacent and adhered to the nanofiber layer, and
optionally a fabric layer subjacent and adhered to the nanofiber layer,
wherein the superjacent and optional subjacent fabric layers are adhered to said nanofiber layer such that the allergen-barrier fabric has a mean flow pore size of between about 0.01 μm and about 10 μm, and a Frazier air permeability of at least about 1.5 m³/min/m².

2. The mattress of claim 1, wherein the allergen-barrier fabric is contained in a mattress ticking.

3. A pillow comprising an allergen-barrier fabric, said allergen-barrier fabric comprising:
a nanofiber layer comprising at least one porous layer of polymeric nanofibers having a number average diameter of said nanofibers between about 50 nm to about 1000 nm, said nanofiber layer having a mean flow pore size of between about 0.01 μm and about 10 μm, a basis weight of between about 1 g/m² and about 30 g/m², a Frazier air permeability of at least about 1.5 m³/min/m²,
a fabric layer superjacent and adhered to the nanofiber layer, and
optionally a fabric layer subjacent and adhered to the nanofiber layer,
wherein the superjacent and optional subjacent fabric layers are adhered to said nanofiber layer such that the allergen-barrier fabric has a mean flow pore size of between about 0.01 μm and about 10 μm, and a Frazier air permeability of at least about 1.5 m³/min/m².

4. The pillow of claim 3, wherein the allergen-barrier fabric is contained in a pillow ticking.

5. A bed covering material comprising an allergen-barrier fabric, said allergen-barrier fabric comprising:
a nanofiber layer comprising at least one porous layer of polymeric nanofibers having a number average diameter of said nanofibers between about 50 nm to about 1000 nm, said nanofiber layer having a mean flow pore size of between about 0.01 μm and about 10 μm, a basis weight of between about 1 g/m² and about 30 g/m², a Frazier air permeability of at least about 1.5 m³/min/m²,
a fabric layer superjacent and adhered to the nanofiber layer, and
optionally a fabric layer subjacent and adhered to the nanofiber layer,
wherein the superjacent and optional subjacent fabric layers are adhered to said nanofiber layer such that the allergen-barrier fabric has a mean flow pore size of between about 0.01 μm and about 10 μm, and a Frazier air permeability of at least about 1.5 m³/min/m².

6. The bed covering of claim 5, wherein said allergen-barrier fabric is contained in a bedspread.

7. The bed covering of claim 5, wherein said allergen-barrier fabric is contained in a duvet cover.

8. The bed covering of claim 5, wherein the allergen-barrier fabric is contained in a mattress cover.

9. The bed covering of claim 5, wherein the allergen-barrier fabric is contained in a mattress pad.

10. The bed covering of claim 5, wherein the allergen-barrier fabric is contained in a pillow cover.

11. A liner for an article susceptible to allergen-penetration comprising an allergen-barrier fabric, said allergen-barrier fabric comprising:
a nanofiber layer comprising at least one porous layer of polymeric nanofibers having a number average diameter of said nanofibers between about 50 nm to about 1000 nm, said nanofiber layer having a mean flow pore size of between about 0.01 μm and about 10 μm, a basis weight of between about 1 g/m² and about 30 g/m², a Frazier air permeability of at least about 1.5 m³/min/m²,
a fabric layer superjacent and adhered to the nanofiber layer, and
optionally a fabric layer subjacent and adhered to the nanofiber layer,
wherein the superjacent and optional subjacent fabric layers are adhered to said nanofiber layer such that the allergen-barrier fabric has a mean flow pore size of between about 0.01 μm and about 10 μm, and a Frazier air permeability of at least about 1.5 m³/min/m².

12. The liner of claim 11, wherein the article susceptible to allergen-penetration is a down jacket.

13. An allergen-barrier fabric comprising:
a nanofiber layer comprising at least one porous layer of polymeric nanofibers having a number average diameter of said nanofibers between about 50 nm to about 1000 nm, said nanofiber layer having a mean flow pore size of between about 0.01 μm and about 10 μm, a basis weight of between about 1 g/m² and about 30 g/m², a Frazier air permeability of at least about 1.5 m³/min/m²,
a fabric layer superjacent and adhered to the nanofiber layer, and
optionally a fabric layer subjacent and adhered to the nanofiber layer,
wherein the superjacent and optional subjacent fabric layers are adhered to said nanofiber layer such that the allergen-barrier fabric has a mean flow pore size of between about 0.01 μm and about 10 μm, and a Frazier air permeability of at least about 1.5 m³/min/m².

14. The allergen-barrier fabric of claim 13, wherein the superjacent and optional subjacent fabric layers are adhered to the nanofiber layer by at least one of thermal adhesion, chemical adhesion or mechanical adhesion.

15. The allergen-barrier fabric of claim 13, which has a durability sufficient to allow at least 10 washings without mechanical separation or delamination of the layers.

16. The allergen-barrier fabric of claim 13, wherein the number average diameter of said nanofibers is between about 300 nm to about 800 nm.

17. The allergen-barrier fabric of claim 13, wherein said nanofiber layer has a mean flow pore size of between about 0.5 μm and about 3 μm.

18. The allergen-barrier fabric of claim 13, wherein said nanofiber layer has a basis weight of between about 2 g/m² and about 30 g/m².

19. The allergen-barrier fabric of claim 13, wherein said allergen-barrier fabric has a Frazier air permeability of at least about 2 m³/min/m².

20. The allergen-barrier fabric of claim 13, wherein the nanofibers are made from a polymer selected from the group consisting of alkyl and aromatic polyamides, polyimides, polybenzimidazoles, polybenzoxazoles, polybenzthiazoles, polyethers, polyesters, polyurethanes, polycarbonates, polyureas, vinyl polymers, acrylic polymers, styrenic polymers, halogenated polyolefins, polydienes, polysulfides, polysaccharides, polylactides, and copolymers, derivative compounds or combinations thereof.

21. The allergen-barrier fabric of claim 13, wherein the superjacent and optional subjacent fabric layers are selected from the group consisting of woven fabrics, knitted fabrics, nonwoven fabrics, scrims and tricots.

22. The allergen-barrier fabric of claim 13, further comprising an antimicrobial finish treatment.

23. The allergen-barrier fabric of claim 13, further comprising a fluid-resistant finish treatment.
